(19) United States
(12) Patent Application Publication
(10) Pub. No.: US 2010/0185574 A1
(43) Pub. Date: Jul. 22, 2010

(54) NETWORK MECHANISMS FOR A RISK BASED INTEROPERABILITY STANDARD FOR SECURITY SYSTEMS

(76) Inventor: Sondre SKATTER, Oakland, CA (US)

Correspondence Address: Patent Docket Department;Armstrong Teasdale LLP, One Metropolitan Square, Suite 2600, St. Louis, MO, 63102-2740, US

(21) Appl. No.: 12/355,739

(22) Filed: Jan. 16, 2009

(51) Int. Cl. G06N 5/02; G06Q 10/00; G06Q 50/00

(52) U.S. Cl. 706/46; 705/7

(57) ABSTRACT

Methods for managing risk values at divestiture (e.g., a passenger checks luggage) and aggregating risk values over a grouped entity (e.g. a passenger with all his/her items).

### CROSS-REFERENCE TO RELATED APPLICATIONS

Not Applicable

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### REFERENCE TO A SEQUENCE LISTING, A TABLE, OR COMPUTER PROGRAM LISTING APPENDIX SUBMITTED ON COMPACT DISC

Not Applicable

### BACKGROUND OF THE INVENTION

1. Field of the Invention

The field of the invention generally relates to security systems for inspecting passengers, luggage, and/or cargo, and more particularly to certain new and useful advances in data fusion protocols for such security systems, of which the following is a specification, reference being had to the drawings accompanying and forming a part of the same.

2. Description of Related Art

Detecting contraband, such as explosives, on passengers, in luggage, and/or in cargo has become increasingly important. Advanced Explosive Detection Systems (EDSs) have been developed that can not only see the shapes of the articles being carried in the luggage but can also determine whether or not the articles contain explosive materials. EDSs include x-ray based machines that operate using computed tomography (CT) or x-ray diffraction (XRD). Explosive Detection Devices (EDDs) have also been developed and differ from EDSs in that EDDs scan for a subset of a range of explosives as specified by the Transportation Security Administration (TSA). EDDs are machines that operate using metal detection, quadrapole resonance (QR), and other types of non-invasive scanning.

A problem of interoperability arises because each EDD and EDS computes and outputs results in a language and/or form that are specific to each system's manufacturer. This problem is addressed, in part, by U.S. Pat. No. 7,366,281, assigned to GE Homeland Protection, Inc, of Newark, Calif. This patent describes a detection systems data fusion protocol (DSFP) that allows different types of security devices and systems to work together. A first security system assesses risk based on probability theory and outputs risk values, which a second security system uses to output final risk values indicative of the presence of a respective type of contraband on a passenger, in luggage, or in cargo.

Development of suitable languages has mostly occurred in two general technology areas. (a) Representation and discovery of meaning on the world wide web for both content and services; and (b) interoperability of sensor networks in military applications, such as tracking and surveillance. The Web Ontology Language (OWL) is a language for defining and instantiating Web-based ontologies. The DARPA Agent Markup Language (DAML) is an agent markup language developed by the Defense Advanced Research Projects Agency (DARPA) for the semantic web. Much of the work in DAML has now been incorporated into OWL. Both OWL and DAML are XML-based.

An extension of the data fusion protocol referenced above into a common language that allows interoperability among different types of EDDs and/or EDSs is needed to deal with (a) how to manage risk values at divestiture (e.g., when luggage is given to transportation and/or security personnel prior to boarding); and (b) how to deal with aggregating risk values over a grouped entity (e.g., a single passenger and all of his or her items).

### BRIEF SUMMARY OF THE INVENTION

Embodiments of the invention address at least the need to provide an interoperability standard for security systems by providing a common language that not only brings forth interoperability, and may further address one or more of the following challenges:

enhancing operational performance by increasing detection and throughput rates and lowering false alarm rates;

ensuring security devices and systems can work together without sharing sensitive and proprietary performance data; and/or

allowing regulators to manage security device and/or system configuration and sensitivity of detection.

The common language provided by embodiments of the invention is more than just a standard data format and communication protocol. In addition to these, it is an ontology, or data model, that represents (a) a set of concepts within a domain and (b) a set of relationships among those concepts, and which is used to reason about one or more objects (e.g., persons and/or items) within the domain.

Compared with OWL and DAML, embodiments of the present security interoperability ontology appear simpler and more structured. For example, embodiments of a security system constructed in accordance with principles of the invention may operate on passengers and the luggage in a serialized fashion without having to detect and discover which objects to scan. This suggests creating embodiments of the present security interoperability ontology that are XML-based. Alternatively, embodiments of the present security interoperability ontology may be OWL-based, which permits greater flexibility for the ontology to evolve over time.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1 is a diagram illustrating preliminary concepts and relationships for a security ontology designed in accordance with an embodiment of the invention;

FIG. 2 is a diagram of an exemplary table that can be constructed and used in accordance with an embodiment of the invention to define a threat space for a predetermined industry;

FIG. 3 is a diagram of an exemplary threat matrix that can be constructed and used in accordance with an embodiment of the invention to define threat vectors and threat types, which can be used to indicate scenarios that need to be screened for and/or to indicate scenarios that do not need to be screened for;

FIG. 4 is a flowchart of an embodiment of a method of translating sensor data to likelihoods;

FIG. 5 is a flowchart of an embodiment of a method of assigning risk values to divested items;

FIG. 6 is a flowchart of an embodiment of a method of aggregating risk values over a single object;

FIG. 7 is a flowchart of an embodiment of a method of performing different types of aggregation;

FIG. 8 is a diagram of a table that identifies the pros and cons of two types of aggregation methods, one or both of which may be performed in an embodiment of the invention; and

FIG. 9 is a flowchart of an embodiment of a method of updating risk values using indirect data received from a sensor, such as a biometric sensor.

Like reference characters designate identical or corresponding components and units throughout the several views, which are not to scale unless otherwise indicated.

### DETAILED DESCRIPTION OF THE INVENTION

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

As required from the ontology definition above, embodiments of the invention define a data model that represents a set of concepts (e.g., objects) within the security domain and the relationships among those concepts. For example, in the aviation security domain, the concepts are: passengers, luggage, shoes, and various kinds of sensors. The scope of the invention, however, should not be limited merely to aviation security. Other types of domains in which embodiments of the invention may be deployed include mass transit security (e.g., trains, buses, cabs, subways, and the like), military security (e.g., main gate and/or checkpoints), city and government security (e.g., city and government buildings and grounds); corporate security (e.g., corporate campuses); private security (e.g., theaters, sports venues, hospitals, etc.), and so forth.

### Concepts and Relationships

Embodiments of the invention also provide a risk representation, which has its own structure, and relates to—or resides in—the passengers and their items. For example, in the aviation security domain, exemplary risk representations include, but are not limited to:

ownership between luggage and passengers;

between sensors and the type of objects it can scan (capability);

between sensors and what type of threats it can detect (capability); and

between risk values and the corresponding physical objects.

Embodiments of the interoperability standard also provide a calculus for updating risk values. This calculus may include one or more of the following:

initialization of risk values;

transformation of existing sensor data to a set of likelihoods;

updating risk values based on new data (sensor or non-sensor data);

aggregation—or rollup—of multiple risk values, which corresponds to threat categories, for an object to a single risk value for that object;

flow down of risk values for “children objects” at divestitures (e.g. a passenger (“parent object” divests his/her checked luggage (“children objects”)); and

aggregation—or rollup—of risk values from several objects into an aggregated value (e.g. a passenger and all his/her belongings, or an entire trip or visit).

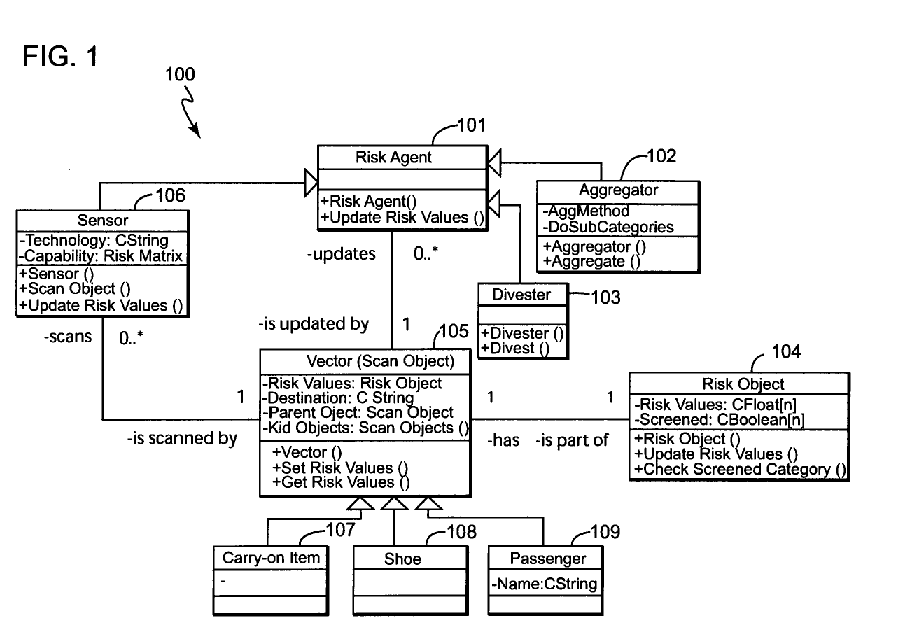

FIG. 1 is a diagram illustrating these preliminary concepts and relationships for an interoperability ontology 100 in a security domain. The interoperability ontology 100 comprises a risk agent 101, which can be exemplified by an aggregator 102, a divester 103, or a sensor 106. A risk agent is coupled with and configured to receive data outputted from a threat vector generator 105, which in turn contains a risk object 104. The threat vector generator 105 holds all the contextual data of a physical item (or vector) such as ownership relationships, and it holds all the risk information. Examples of threat vectors may include, but are not limited to: carry-on item 107, shoe 108, and passenger 109. As explained further with respect to FIG. 3, a threat scenario is a possibility assigned for an intersection of a predetermined threat type (e.g., explosive, gun, blades, other contraband, etc.) with a predetermined threat vector. Thus, one threat scenario could be whether a laptop contains an explosive. Another threat scenario could be whether a checked bag contains a gun. Another threat scenario could be whether a person conceals a gun. And so forth.

Each of objects 101, 102, 103, 104, 105, and 106 represents a series of computer-executable instructions, that when executed by a computer processor, cause the processor to perform one or more actions. For example, the risk agent object 101 functions to receive and update one or more risk values associated with one or more types of threats in one or more kinds of threat vectors. The aggregator object 102 functions to determine whether and what type of aggregation method (if any) will be used. The aggregator object 102 also functions to sum risk values for sub-categories (if any) of an object (e.g., a person or their item(s)). In a similar fashion, the divester object 103 determines whether an item has been divested from a passenger and what risk value(s) are to be assigned to the divested item(s). Examples of divested items include, but are not limited to: a piece of checked luggage (e.g., a “bag”), a laptop computer, a cell phone, a personal digital assistant (PDA), a music player, a camera, a shoe, a personal effect, and so forth. The threat vector generator object 105 functions to create, build, output, and/or display a threat matrix (see FIG. 3) that contains one or more risk values for one or more threat vectors and threat types. The threat matrix and its components are described in detail below. The risk object 104 functions to calculate, assign, and/or update risk values. The risk values may be calculated, assigned, and/or updated based, at least in part, on whether a sensor has been able to successfully screen for a threat category that it is configured to detect. The risk object 104 is configured to assign and/or to change a Boolean value for each threat category depending on data received from each sensor.

An example of a Boolean value for a threat category is “1” for True and “0” for False. The Boolean value “1” indicates that a sensor performed its screen. The Boolean value “0” may indicate that a screen was not performed.

### Sensors and Services

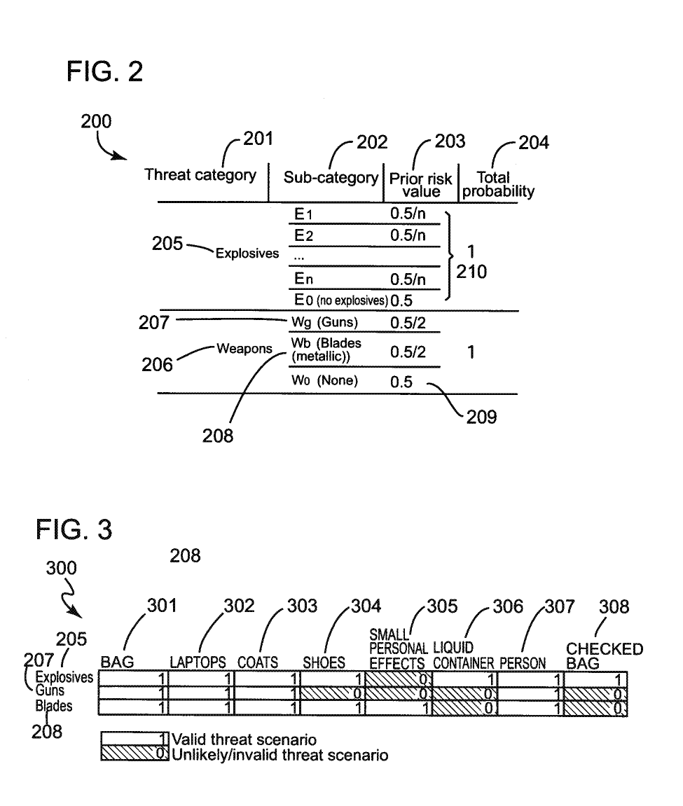

“Sensor” designates any device that can screen any of the threat vectors listed in the threat matrix 300 (see description of FIG. 3 below) for any of the threat types listed in FIG. 2 (see description of FIG. 2 below). The combination of threat types and threat vectors that a sensor can process is defined as the service provided by the sensor. In an embodiment, each sensor provides an interface where it replies to a query from a computer processor as to what services the sensor offers. Basic XML syntax suffices to describe this service coverage. For example, a “puffing device” offers the service of explosive detection (and all subcategories thereof) on a passenger and in shoes. In FIG. 1 the list of services for each sensor is stored in a Capability data member of the sensor object 106.

The sensor is any type of device configured to directly detect a desired threat and/or to provide indirect data (such as biometric data) that can be used to verify an identity of a passenger. Examples of sensor include, but are not limited to: an x-ray detector, a chemical detector, a biological agent detector, a density detector, a biometric detector, and so forth.

### Threat Space

FIG. 2 is a diagram of an exemplary table 200 that can be constructed and used in accordance with an embodiment of the invention to define a “threat space” for a predetermined domain. The term “threat space,” designates the types of threats that are considered to be likely in a given security scenario, and thus should be screened for. In an aviation security domain, the threat space may include at least explosives and/or weapons (neglecting weapons of mass destruction for now).

The table 200 includes columns 201, 202, 203, and 204; a first category row 205 having sub-category rows 210; and a second category row 206 having sub-category rows 207, 208, and 209. Column 201 lists threat categories, such as explosives (on row 205) and weapons (on row 206). Column 202 lists sub-categories. For row 205 (explosives), the sub-categories listed on rows 210 are E₁, E₂ . . . Eₙ, and E₀ (no explosives). For row 206 (weapons), the sub-categories listed are: W_{g} (Guns) on row 207; W_{b} (Blades (Metallic)) on row 208; and W₀ (None) on row 209. Column 203 lists prior risk values (0.5/n for rows 210, except for E₀ (no explosives), which has a prior risk value of 0.5). Column 203 also lists prior risk values (0.5/2) for rows 207 and 208; and lists a prior risk value of 0.5 for row 209. These risk values are probabilities that are updated as more information is extracted by sensors and/or from non-sensor data. Column 204 lists a total probability value of 1 for each of rows 205 and 206.

Separation of the threat categories 205 (explosives) and 206 (weapons) into subcategories optimizes data fusion. The benefits of this subdivision become apparent when considering the detection problem inversely: If sensor A eliminates categories 1, 2, 3, while sensor B eliminates categories 4, . . . , n, then—put together—they eliminate all categories 1 to n. This would not have been possible without incorporating the “threat space” and the subcategories into the interoperability language.

### Threat Matrix

In aviation security, the threat vehicle focuses around the passenger. Potentially, each passenger can be treated differently, based either on passenger data that was available prior to arrival or on data that was gathered at the airport. Associated with each passenger, then, is a risk value, which is an instantiation of the threat space as defined in FIG. 2. The risk values per passenger (or other item) may be referred to as the threat status.

Other threat vectors of interest are:

Checked luggage

Checkpoint items:
Carry-on luggage
Laptop
Shoes
Coats
Liquid container
Small personal effects
Person
   Foot area
   Non-foot area

A simplifying constraint arises from the fact that not all threat types (e.g., explosives, guns, blades, etc.) can be contained in all threat vectors. For example, small personal effects are considered not to contain explosives, but could conceal a blade. Similarly, a shoe is assumed not to contain guns, but may conceal explosives and blades. These constraints are summarized below the threat matrix 300 of FIG. 3.

The threat matrix 300 comprises columns 301, 302, 303, 304, 305, 306, 307, and 308, and rows 205, 207, and 208; all of which can be used to indicate scenarios that need to be screened for and/or to indicate scenarios that do not need to be screened for. For example, column 301 represents a piece of luggage; column 302 represents a laptop; column 303 represents a coat; column 304 represents a shoe; column 305 represents personal effects; column 306 represents a liquid container; column 307 represents a passenger; and column 308 represents a checked bag. Row 205 represents an explosive; row 207 represents a gun; and row 208 represents a blade. Boolean values (“1” for a valid threat scenario and “0” for an unlikely/invalid threat scenario) appear in the intersection of each row and column. For example, a Boolean value of “1” appears at the intersection of row 205 (explosive) and columns 301 (bag), 302 (laptop), 303 (coat), 304 (shoes), 306 (liquid container), 307 (passenger), and 308 (checked bag), indicating that an explosive may be concealed in a bag, a laptop, a coat, a shoe, a liquid container, on a passenger, or in a checked bag. The Boolean value of “0” appears at the intersection of row 205 (explosive) and column 305 (personal effects), indicating that concealment of an explosive in a person's personal effects is unlikely.

### Risk Calculus

The risk values, or threat status, are measured in probability values, more specifically using Bayesian statistics. In addition, as previously mentioned, there is a Boolean value associated with each threat category, which specifies whether this threat type has been screened for yet—or serviced. This value may start out as False, (e.g., “0”).

“Priors” or “prior risk values) are initial values of the threat status, as stated in column 203 of the table depicted in FIG. 2. In an embodiment, the priors are set so that the probability of a threat item being present is 50%. This is sometimes referred to as a uniform—or vague—prior. However, this is not a realistic choice of prior, considering that the true probability that a random passenger is on a terrorist mission is miniscule. However, the prior does not need to be realistic as long as it is consistent. In other words, if same prior is always used, the interpretation of subsequent risk values will also be consistent.

The two exemplary threat types of FIG. 2—explosives (row 205) and weapons (row 206)—are accounted for separately. The sum of P(E₀), P(E₁), . . . (Eₙ) equals a likelihood of 1. And the sum of the weapons risk values, P(W₀)+P(W_{g})+P(W_{b}) also equals a likelihood of 1.

### Method of Translating Sensor Data to Likelihoods

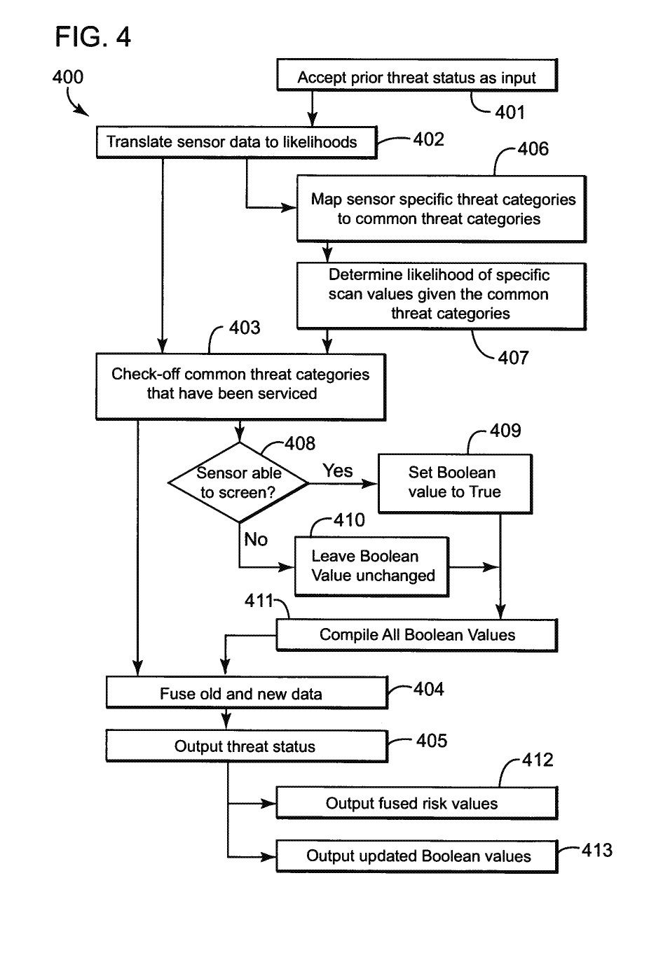

FIG. 4 is a flowchart of an embodiment of a method 400 of translating sensor data to likelihoods. Unless otherwise indicated, the steps 401, 402, 403, 404, 405, 406, 407, 408, 409, 410, 411, 412, and 413 may be performed in any suitable order.

The method 400 may begin by (a sensor) accepting 401 a prior threat status as an input. Thus each sensor in a security system must be able to accept an input threat status along with the physical scan item (person, bag, etc.). This prior threat status might be the initial threat status as described above, or it might have been modified by another sensor and/or based on non-sensor data before arriving at said sensor.

The method 400 may further comprise translating 402 sensor data into likelihoods. In one embodiment, this entails two sub-steps. A first sub-step 406 may comprise mapping sensor specific threat categories to common threat categories. This was described above with respect to the table shown in FIG. 2. The sensor specific categories may vary depending on the underlying technology; some sensors will have chemically specific categories, whereas others will be based on other physical characteristics such as density. A second sub-step 407 may comprise determining the likelihood of specific scan values given the various common threat categories. In one embodiment, this is purely based on pre-existing “training data” for the sensor. In a simplest case, the likelihoods are detection rates and/or false alarm rates.

The likelihoods can be written mathematically as P(X|Wᵢ,Eⱼ), where X is the measurement or output of the sensor. For the simplest case, when the sensor outputs Alarm or Clear, the likelihood matrix is simply the detection rates and false alarm rates, as shown below.

$$P ( Alarm \vert {E}_{i} ) = \{ \begin{matrix}Pd ( i ) , & i = 1 , 2 , … n \\ Pfa , & i = 0\end{matrix} \\ P ( Clear \vert {E}_{i} ) = \{ \begin{matrix}1 - Pd ( i ) , & i = 1 , 2 , … n \\ 1 - Pfa , & i = 0\end{matrix}$$

Better data fusion results may be obtained when determining the likelihoods from continuous feature(s) rather than a discrete output (Alarm/Clear). In such a case, the likelihoods can be computed from probability density functions, which in turn can be based on the histograms of training data. _{[SS1]}

The method 400 may further comprise checking off 403 common threat categories that have been serviced by a sensor. In one embodiment, this may entail one or more substeps. For example, a first sub-step may be determining 408 whether a sensor has been able to screen for a threat category that it is capable of detecting. If so, a second sub-step may comprise setting a Boolean value for this category to True—irrespective of the category's prior Boolean value. Otherwise, if the sensor was unable to perform its usual inspection/screening due to limitations such as shield alarm (CT and X-ray) or electrical interference, the second sub-step may comprise leaving 410 the Boolean value unchanged. If a common threat category contains sub-categories, the Boolean values extend down to subcategories as well. In such a case, a third sub-step may comprise compiling (or rolling up) all Boolean values with the logical “AND” operation.

The method 400 may further comprise fusing 404 old and new data. This may be accomplished by configuring each sensor to combine its likelihood values with the input threat status (e.g., priors) using Bayes' rule:

$$P ( {E}_{i} \vert X ) = \frac{P ( X \vert {E}_{i} ) P ( {E}_{i} )}{{\sum }_{j = 0}^{n} P ( X \vert {E}_{j} ) P ( {E}_{j} )}$$

$$P ( {W}_{i} \vert X ) = \frac{P ( X \vert {W}_{i} ) P ( {W}_{i} )}{{\sum }_{j = 0 , b , g} P ( X \vert {W}_{j} ) P ( {W}_{j} )}$$

Bayes' rule is used to compute the posterior risk values, P(Eᵢ|X), from the priors, P(Eᵢ), and the likelihoods provided by the sensors, P(X|Eᵢ).

The method 400 may further comprise outputting 405 a threat status. This may involve two sub-steps. A first sub-step may comprise outputting 406 fused risk values. A second sub-step may comprise outputting updated Boolean values.

### Network Description

A critical part of the security ontology is the passing of threat status between threat vectors that “emerges” with time. For example, at the time a passenger registers at an airport, his identity is captured and a threat status can be instantiated and initialized. Later on, the same passenger divests of various belongings, which will travel their own path through security sensors.

The interoperability requirements of sensors and meta-sensors were described above. Such sensors have the role of propagating the risk values; meaning they receive pre-existing risk values as input, update them based on measurements, and output the result.

This section describes the governing rules for creation, divestiture, and re-aggregation of threat status. As FIG. 1 illustrated, there are one or more software agents—central or distributed—outside of the sensor nodes that manage the flow of risk values through the various screening sensors. In most cases, there will also be a central entity (e.g., a database or risk agent object 101), which is aware of the entire scene. Either way, there is a need to perform the flow of threat status between multiple sensors, which includes:

divestiture;

aggregation (risk rollup);

initialization; and

decision rules (alarm/clear, re-direction rules, etc.)

Accordingly, architectural choices of the interoperability standard address the following:

(1) What rules guide a handoff of a threat status to divested items? Moreover, how does divestiture affect the threat status of the divestor—if at all—and vice versa?

(2) How is threat status computed for an aggregation of items? Examples are a) a passenger and all her items, or b) all passengers and items that are headed on a particular trip.

Details on these architectural choices are presented below.

### Divestiture—Passing Risk Values to Divested Items

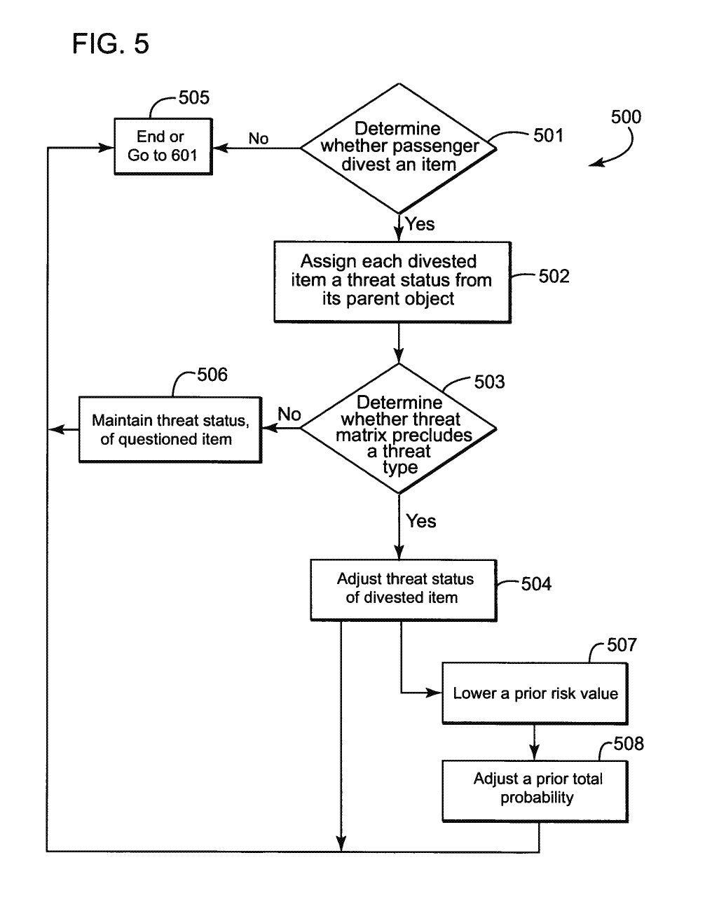

FIG. 5 is a flowchart 500 of an embodiment of a method of assigning risk values to divested items. The method 500 may begin by determining 501 whether a passenger has divested an item. If no, the method 500 may end 505. Alternatively, the method 500 may proceed to step 601 of method 600—described below. If the passenger has divested an item, the method further comprises assigning 502 each divested item a threat status from its parent object (in this case the threat status of the passenger). The method 500 may further comprise determining 503 whether a threat matrix (described above) precludes a threat type (or threat scenario). If no threat type is precluded, the method 500 may comprise maintaining 506 divested items threat status without change. If a threat type is precluded, the method 500 may comprise adjusting 504 the threat status of the divested item. This step 504 may comprise several sub-steps. A first sub-step 507 may comprise lowering a prior risk value. A second sub-step 508 may comprise adjusting a prior total probability. Thereafter, the method 500 may end 505, or proceed to step 601 of method 600 described below.

Thus, each divested object inherits the threat status, i.e. the risk values, from the parent object. Only if the threat matrix in FIG. 3 precludes a threat type, can the associated risk value be lowered accordingly.

The justification for this requirement is that, for security purposes, one cannot allow divestitures to dilute the risk values. For example, a passenger who checks two bags should not receive lower risk values for each bag than a passenger that checks only one bag. This would become a security hole: bringing multiple bags would lower the risk value for each bag and thus potentially relax the screening.

The disadvantage of this requirement is loss of consistency in the risk values before and after divestiture: If a passenger is deemed 50% likely of carrying a bomb, one could argue that the total risk after divestiture—the combined risk of the person and the two checked bags—also should be 50%. This loss of consistency is acceptable to avert a security hole. Consistency on aggregated items will be regained by a risk roll-up mechanism (described below).

### Aggregating Risk Values for a Single Object

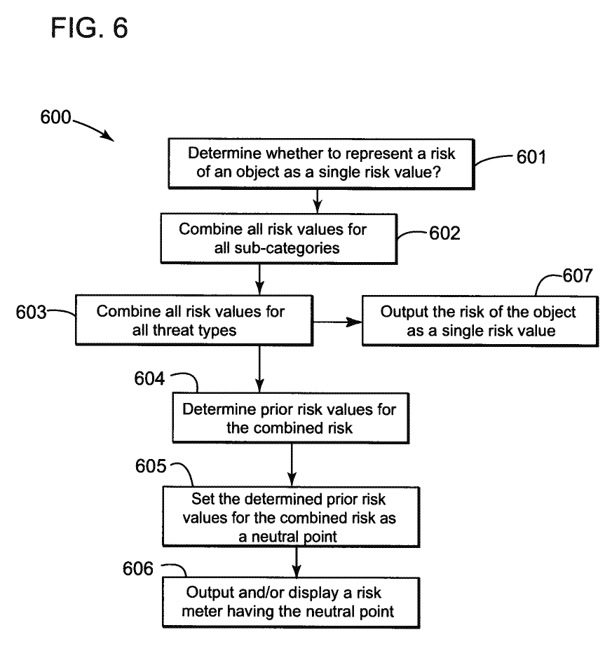

FIG. 6 is a flowchart of an embodiment of a method 600 of aggregating risk values for a single object. The method 600 may begin by determining whether to represent a risk of an object as a single risk value. This is accomplished in several steps, e.g., by combining 602 all risk values for all sub-categories, and by combining 603 all risk values for all threat types. For sake of illustration, consider the exemplary threat space defined in FIG. 2 for which there were two main threat categories, Explosives (E) (row 205) and Weapons (W) (row 206). Combining the risk values of the sub-categories in such a case is done by simple addition.

$$P ( E ) = {\sum }_{j = 1}^{n} P ( {E}_{j} )$$

$$P ( W ) = {\sum }_{j = b , g} P ( {W}_{j} )$$

To get the combined risk of the two main threat categories, E and W, basic probability calculus is used:

P=P(E∪W)=1−(1−P(E))(1−P(W))

Thus, step 602 may comprise several sub-steps 604, 605, and 606. Sub-step 604 may comprise determining a prior risk value for the combined risk. In the present example, the prior risk value for the combined risk will not be 0.5, but 0.75. Sub-step 605 may comprise setting the determined prior risk value for the combined risk as a neutral point. In this example, the neutral state of the risk value 0.75—before any real information has been introduced—is “off balance” compared to the initial choice of 50/50. For a visual display of the risk value in a risk meter, it is therefore natural to make the neutral point on the gage (transition from green risk to red risk) at 0.75. Accordingly, sub-step 606 may comprise outputting and/or displaying a risk meter having the neutral point and/or the single risk value.

Moving forward from either step 602 or 603, the method 600 may comprise outputting 607 the risk of the object as a single risk value.

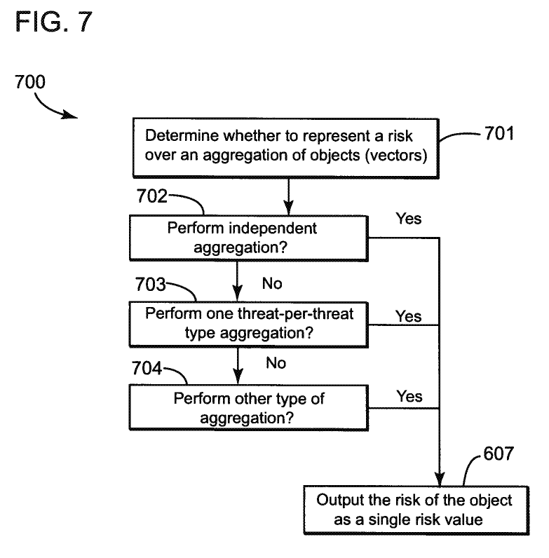

FIG. 7 is a flowchart of an embodiment of a method 700 of performing different types of aggregation. The method may comprise determining 701 whether to represent risk over an aggregation of objects (vectors). If no, the method 700 may end. If yes, the method 700 may comprises determining 702 whether to perform an independent aggregation. If yes, the method 700 may comprise performing the independent aggregation and outputting 607 the risk of the object as a single risk value. If no, the method 700 may comprise determining 703 whether to perform a one-threat per-threat type aggregation. If yes, the method 700 may comprise performing the one threat per-threat type aggregation and outputting 607 the risk of the object as a single risk value. If no, the method 700 may comprise determining 704 whether to perform another type of aggregation. If yes, the method 700 may comprise performing the other type of aggregation and outputting 607 the risk of the object as a single risk value.

From a technical standpoint, there are several possible aggregation mechanisms. For example, the probability values could simply be summed, or averaged. Or, one could assume independence between items, or assume only one threat of each type for the whole aggregation. Because, each of the methods has its pros and cons, it embodiments of the interoperability standard support more than one aggregation method.

### Aggregating Assuming Independence

Assuming that each item in the aggregation is independent, there is no limitation on the total number of threats within the aggregation. The independence assumption also makes the aggregation trivial. For example, let k denote the item number, with K being the total number of items in the aggregation. Double indices for the threat category are then used: the first index for the sub-category, and the second index for the item. This yields the following calculus:

$${P}_{agg} = 1 - {\prod }_{k = 1}^{K} P ( {E}_{0 k} ) P ( {W}_{0 k} )$$

Illustratively, this methodology can be used when aggregating truly independent items, such as different passengers.

### Aggregating Assuming Maximum One Threat

### Per Threat Type Over the Aggregation

This method is analogous to the one used for the sub-categories of a single item that were described above with reference to FIG. 2. It is more complicated to compute because the priors have to be re-assigned for each item to satisfy the one-threat-only assumption. This method is preferable when aggregating all objects associated with a person, since a person already started out with a “one-threat-only” assumption in the prior.

### Other Types of Aggregation Methods

In other situations other aggregation methodologies may be better suited. Therefore, the architecture of the interoperability standard may be kept open with respect to overriding the two aggregation methodologies proposed above.

### Aggregating Risk Value Over Multiple Objects

In an embodiment, a purpose of aggregation may be to utilize the risk values in a Command and Control (C&C) context. In such a scenario, risk values provided by an embodiment of the interoperability standard feed into a C&C context where agents—electronic or human—are combing for big-picture trends. Such efforts might foil plots where a passenger is putting small amounts of explosives in different bags, or across the bags of multiple passengers. It could also reveal coordinated attacks across several venues. It also can be used to assign a global risk to a person based on all the screening results.

An aggregation over multiple objects may be defined as a hierarchical structure such as a passenger and the belonging items, or a flight including its passengers. This means there must be some “container” objects such as a flight, which contains a link to all the passengers. An alternative implementation uses a database to look up all the passengers and items for a given flight number.

### Pros and Cons of Aggregation Methodologies

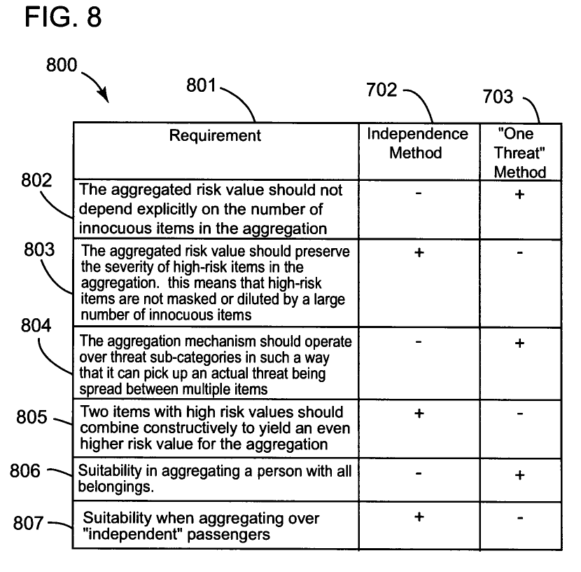

FIG. 8 is a diagram 800 of a table that identifies the requirements 801 and pros and cons of two types of aggregation methods 701 and 702, one or both of which may be performed in an embodiment of the invention. Requirement 802 is that the aggregated risk value should not depend explicitly on the number of innocuous items in the aggregation. This is a minus for the independence aggregation method 702, and a plus for the one-threat aggregation method 703.

Requirement 803 is that the aggregated risk value should preserve the severity of high-risk items in the aggregation. This means that high-risk items are not masked or diluted by a large number of innocuous items. This is a plus for the independence aggregation method 702, and a minus for the one-threat aggregation method 703.

Requirement 804 is that the aggregation mechanism should operate over threat sub-categories in such a way that it can pick up an actual threat being spread between multiple items. This is a minus for the independence aggregation method 702, and a plus for the one-threat aggregation method 703.

Requirement 805 is that two items with high-risk values should combine constructively to yield an even higher risk value for the aggregation. This is a plus for the independence aggregation method 702, and a minus for the one-threat aggregation method 703.

Requirement 806 is the suitability in aggregating a person with all belongings. This is a minus for the independence aggregation method 702, and a plus for the one-threat aggregation method 703.

Requirement 807 is the suitability when aggregating over “independent” passengers. This is a plus for the independence aggregation method 702, and a minus for the one-threat aggregation method 703.

### Non-Sensor Data Nodes (Passenger Profiling System)

In an embodiment of the interoperability standard, the risk engine (DSFP) also supports receiving and using information from sources other than sensors. For example, a passenger profiling system may be integrated with the interoperability standard. There are no additional requirements for such non-sensor data nodes—but for clarity, the following example is provided.

Suppose that a passenger classification system categorizes passengers into two categories: normal and selectee. This classification system is characterized by its performance, more specifically by the two error classification rates:

(a) The false positives is the rate that innocent passengers are placed in the selectee category. This rate is easily measurable as the rate that “normal” passengers at an airport are classified as selectee. For our example, let's assume the rate is 5%.

(b) The false negatives rate is the percentage of real terrorists that are placed in the normal category. In this case, since there is no data available, we would have to use an expert's best guess to come up with a value. For this example we will assume there is a 50% chance that the terrorist will not be detected and thus ends up being classified as normal.

In an embodiment, the % of false positives and the % of false negatives are received from the profiling system that calculated them. To comply with the requirements above, the passenger-profiling node needs to determine the likelihoods:

P(Selectee|Eᵢ) and P(Normal|Eᵢ)

For brevity, we only consider the explosive categories here; the weapons categories behave the same way. Now note that E₁, . . . , Eₙ means there are real threats on the person or his belongings, i.e. he is a terrorist on a mission. Based on the error rates above then,

$$P ( Selectee \vert {E}_{i} ) = \{ \begin{matrix}0.5 , & i = 1 , 2 , … n \\ 0.05 , & i = 0\end{matrix} \\ P ( Normal \vert {E}_{i} ) = \{ \begin{matrix}0.5 , & i = 1 , 2 , … n \\ 0.95 , & i = 0\end{matrix}$$

By using these likelihoods with Bayes' rule, a passenger categorized as normal would have his risk value change from 50% to 35%. A passenger designated a selectee would have his risk value change to 91%. Each risk value is the sum of P(E₁),P(E₂,) . . . , P(Eₙ). The reduction of risk value from 50% to 35% was obtained by simply applying Bayes' rule with the likelihoods stated above.

A profiling method with higher misclassification rates would reduce leverage on the risk values. If for example, the false negatives rate, i.e. the rate of classifying terrorists on a mission as normal, is 75%, the resulting risk values would be 44% for normal and 83% for selectee.

Sensors with Indirect Data

This section builds upon the example in the last section and further describes how to transform data from biometric sensors and other types of sensors that output indirect data. “Indirect data” is a measurement result obtained from a sensor that does not directly indicate whether a threat (e.g., a weapon, an explosive, or other type of contraband) is present. Non-limiting examples of “indirect data” include a fingerprint, a voiceprint, a picture of a face, and the like. None of these measurements directly indicate whether a threat is present, but only whether the measurement matches or does not match similar items in a database. On the other hand, non-limiting examples of “direct data” are: an x-ray measurement that clearly defines the outline of a gun, a spectroscopic analysis that clearly identifies explosive residue, etc. In particular, this section describes how to convert the identity verification modality of biometric sensors to a risk metric that can be used in an embodiment of the interoperability ontology described above.

Converting an identity verification result into overall risk assessment quantifies the risk associated with the biometric measurement result. This is an advantage over prior biometric-based security systems in which biometric identity verification is usually used purely in a green light/red light mode.

Biometric sensors present another challenge because, in addition to utilizing the inherent likelihood functions that characterize a biometric sensor's capability, (a) the likelihood that a terrorist is using a false identity and (b) the likelihood that an “innocent” passenger (non-terrorist) is using false identity need to be determined.

Note that these two likelihoods are completely independent of the underlying biometric technology, i.e. these likelihood values would be identical for all biometric sensors.

That said, in an embodiment of the invention, biometric sensors are configured to compute likelihoods that a biometric sample is a match or a non-match. These likelihoods may be compounded with the two basic identity verification likelihoods described above, to produce an overall identity verification likelihood that can be used with an embodiment of the interoperability standard.

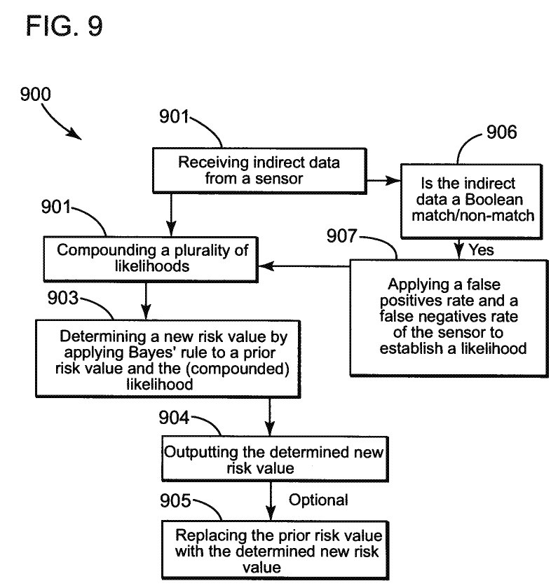

FIG. 9 is a flowchart of an embodiment of a method 900 of updating risk values using indirect data received from a sensor, such as a biometric sensor. The method 900 may comprise receiving 901 indirect data from a sensor. In one embodiment, the sensor from which indirect data is received is a biometric sensor. The indirect data may indicate a matching score for a biometric sample, which in turn can be turned into a likelihood that the person's identity is matches the alleged identity and/or the likelihood that the person's identity is not the alleged identity. The indirect data may also be a Boolean match (1) or a Boolean non-match (0). In one embodiment, the method 900 comprises determining 906 whether the indirect data is a Boolean match (1) or non-match (0). Thereafter, the method 900 may further comprise applying 907 the false positives rate and false negative rates of the sensor to establish a likelihood. After step 907, the method 900 may further comprise compounding 902 a plurality of likelihoods to produce a compounded likelihood. In an embodiment, the step 902 comprises: compounding the established likelihood with a pre-existing likelihood. The term “compounding likelihoods” generally refers to the mathematical operation of multiplication, and is further described and explained below.

In another embodiment, immediately following step 901, the method 900 may further comprise compounding 902 a plurality of likelihoods to produce a compounded likelihood. In one embodiment, this step 902 may comprise compounding a likelihood of identity match defined above with a pre-established likelihood that a terrorist would use a false identity and/or with a likelihood that a non-terrorist (e.g., passenger) would use a false identity. The method may further comprise determining 903 new risk values by applying Bayes' rule to the prior risk value and the compounded likelihood. The method 900 may further comprise outputting 904 a new risk value. The method 900 may further comprise replacing 905 the prior risk value with the determined new risk value.

A full example how to update a risk value using indirect data from a sensor is given below.

### Exemplary Computation of Likelihood

The section titled “Sensors With Indirect Data” described two likelihoods that need to be determined: (a) the likelihood that a terrorist is using a false identity and (b) the likelihood that an “innocent” passenger (non-terrorist) is using false identity. In this example, both likelihoods are assigned values for purposes of illustration only. Assume it is 2% likely that a normal passenger would use a false identity and 20% likely that a terrorist on a mission would do so.

We then have:

$$P ( FalseIdentity \vert {E}_{i} ) = \{ \begin{matrix}0.2 , & i = 1 , 2 , … n \\ 0.02 , & i = 0\end{matrix} \\ P ( TrueIdentity \vert {E}_{i} ) = \{ \begin{matrix}0.8 , & i = 1 , 2 , … n \\ 0.98 , & i = 0\end{matrix}$$

Also assume for this example only that a fingerprint (e.g., one type of biometric) sensor produces a matching score that indicates that the likelihood of a match is three (3) times the likelihood of a non-match. We then have:

P(Score|FalseIdentity)=k

P(Score|TrueIdentity)=3k

These likelihoods [P(FalseIdentity/Eᵢ); P(TrueIdentity/Eᵢ); P(Score/False Identity); and P(Score/True Identity)] need to be compounded to produce a compounded likelihood P(Score|Eᵢ), which can be written as:

$$\begin{matrix}P ( Score \vert {E}_{i} ) = P ( Score \vert FalseIdentity ) P ( FalseIdentity \vert {E}_{i} ) + \\ P ( Score \vert TrueIdentity ) P ( TrueIdentity \vert {E}_{i} ) \\ = 0.01 P ( FalseIdentity \vert {E}_{i} ) + 0.03 P ( TrueIdentity \vert {E}_{i} ) \\ = \{ \begin{matrix}2.60 k , & i = 1 , 2 , … n \\ 2.96 k , & i = 0\end{matrix}\end{matrix}$$

Finally, the risk values are updated by applying Bayes' rule. This calculation shows that a passenger with the matching score from this example would have her risk value reduced from 50% to 47%. Thus, the high matching score of the biometric sensor reduced the perceived risk of the passenger.

In another example, the biometric sensor produced a matching score such that the likelihood of non-match was twice as great as the likelihood of a match. This means that there is doubt about the true identity of the passenger and the risk value increases to 57%.

FIGS. 4, 5, 6, 7 and 9 are each a block diagram of a computer-implemented method. Each block, or combination of blocks, depicted in each block diagram can be implemented by computer program instructions. These computer program instructions may be loaded onto, or otherwise executable by, a computer or other programmable apparatus to produce a machine, such that the instructions that execute on the computer or other programmable apparatus create means or devices for implementing the functions specified in the block diagram. These computer program instructions may also be stored in a computer-readable memory that can direct a computer or other programmable apparatus to function in a particular manner, such that the instructions stored in the computer-readable memory produce an article of manufacture, including instruction means or devices which implement the functions specified in each block diagram.

This written description uses examples to disclose embodiments of the invention, including the best mode, and also to enable a person of ordinary skill in the art to make and use embodiments of the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection.

Moreover, any embodiments disclosed in the subject application are not to be taken as the only possible embodiments. Other embodiments will occur to those skilled in the art and are within the scope of the following claims.

What is claimed is:

1. A method, comprising:
determining whether a passenger has divested an item;
if yes, assigning each divested item a threat status from the passenger;
determining whether a threat matrix precludes a threat type;
if no, maintaining the divested item's threat status; and
if yes, adjusting the divested item's threat status.

2. The method of claim 1, wherein the step of adjusting the divested item's threat status further comprises:
lowering a prior risk value; and
adjusting a prior total probability.

3. A method, comprising:
determining whether to represent a risk of an object as a single risk value;
if yes, combining at least one of (a) all risk values for all threat categories and (b) all risk values for all sub-categories; and
outputting the risk of the object as a single risk value.

4. The method of claim 3, wherein the step of combining all risk values for all threat categories further comprises performing an independent aggregation over one or more threat vectors.

5. The method of claim 3, wherein the step of combining all risk values for all subcategories further comprises adding all the sub-category risk values.

6. A method, comprising:
determining whether to represent a risk of an aggregation of objects;
if yes, performing one of (a) an independent aggregation and (b) a one threat-per threat type aggregation; and
outputting, as a result of either the independent aggregation or the one threat-per-threat type aggregation, the risk of the aggregation of objects as a single risk value.

7. A method of updating risk values using indirect data received from a sensor, the method comprising:
receiving indirect data from the sensor;
compounding a plurality of likelihoods, at least one of which is based on the received indirect data, to produce a compounded likelihood;
determining a new risk value by applying Bayes' rule to a prior risk value and the compounded likelihood; and
outputting the determined new risk value.

8. The method of claim 7, further comprising:
replacing the prior risk value with the determined new risk value.

9. The method of claim 7, wherein the sensor from which indirect data is received is a biometric sensor.

10. The method of claim 7, wherein the indirect data indicates a matching score for a biometric sample, which in turn can be turned into a likelihood that a person's identity matches an alleged identity.

11. The method of claim 7, wherein the indirect data indicates a matching score for a biometric sample, which in turn can be turned into a likelihood that a person's identity is not the alleged identity.

12. The method of claim 7, wherein the indirect data is one of a Boolean match (1) or a Boolean non-match (0).

13. A method of updating risk values using indirect data received from a sensor, the method comprising:
receiving indirect data from the sensor, wherein the indirect data is one of a Boolean match (1) or a Boolean non-match (0);
applying a false positives rate and a false negative rate of the sensor to establish a likelihood;
compounding the likelihood with a pre-existing likelihood;
determining a new risk value by applying Bayes' rule to a prior risk value and the likelihood; and
outputting the determined new risk value.

14. The method of claim 13, further comprising:
replacing the prior risk value with the determined new risk value.

15. The method of claim 13, wherein the sensor from which indirect data is received is a biometric sensor.

16. The method of claim 13, wherein the indirect data indicates a matching score for a biometric sample, which in turn can be turned into a likelihood that a person's identity matches an alleged identity.

17. The method of claim 13, wherein the indirect data indicates a matching score for a biometric sample, which in turn can be turned into a likelihood that a person's identity is not the alleged identity.
